(19) United States
(12) Patent Application Publication
(10) Pub. No.: US 2026/0335900 A1
(43) Pub. Date: Oct. 29, 2026

(54) WEAR PART AND METHOD FOR MANUFACTURING THE SAME

(71) Applicant: METSO FINLAND OY, Espoo (FI)

(72) Inventors: Rafael Yanata, Sorocaba (BR); Rosalino Ortega, Woodstock, IL (US); Vesa Villman, Tampere (FI)

(73) Assignee: METSO FINLAND OY, Espoo (FI)

(21) Appl. No.: 19/187,025

(22) Filed: Apr. 23, 2025

(51) Int. Cl. B02C 2/00

(52) U.S. Cl. CPC B02C 2/005; B02C 2210/02

(57) ABSTRACT

A method for manufacturing a wear part that includes the steps of forming a body having at least one socket formed in or on the body. At least one insert of a wear resistant material is provided and configured to be received by the socket. A retainer is provided that includes a first retaining component. The wear resistant insert is retained in the socket by means of the retainer. The method is characterized in that, with the wear resistant insert at least partially received by the socket, the first retaining component is at least partially inserted into a gap between the wear resistant insert and the body, and a force is applied onto the first retaining component and/or onto the wear resistant insert, to thereby create a retaining force to retain the wear resistant insert in the socket.

### TECHNICAL FIELD

The present invention relates to a wear part, comprising a body of a basic material and at least one insert of a wear resistant material. The invention also relates to a method for manufacturing said wear part.

### BACKGROUND OF THE INVENTION

Wear resistant constructions and components are used, for example, in equipment for reducing the size of material, such as rocks, stones, ores, or other materials to be crushed, or for the recycling of materials. In these processes, material to be crushed is pressed between wear resistant components or constructions, or otherwise collides against surfaces of the wear resistant constructions or components, to thereby crush the material. Examples of equipment used in these processes are crushers for use in, e.g., the mining industry, including gyratory crushers, cone crushers, and jaw crushers, comprising supporting surfaces or frames acting as a mounting base to which said wear resistant constructions or components are attached.

The crushing of material causes wear on the surfaces of the wear resistant components or constructions in an amount depending on the surface pressure of the contacts, velocities, material characteristics of the component or construction surfaces and the physical characteristics of the material to be crushed, like the compressive strength and tribology characteristics. Once a wear resistant construction or component is worn out, it needs to be replaced, causing downtime of the equipment utilizing the wear resistant construction or component.

In general, the industry aims to increase the effective lifetime of such wear resistant constructions and components by choosing advantageous materials. The tribology characteristics of metallic wear resistant materials of prior art solutions are modified, for example, by alloying the metals in question, and eventual adding particles, or by manufacturing processes and further treatments of the materials, like heat treatments, whereby phases with better resistance against wear phenomena than usual will be formed in their microstructure.

Said phases typically exhibit a relatively high material hardness, but often have low toughness and fatigue resistance. Therefore, wear resistant constructions and components for use in the above-mentioned equipment are in practice not entirely formed of materials having the microstructure described above.

In a solution known from WO 2007/085694 A1, pieces of a wear resistant material are joined to a wear part at predetermined positions. Here, the wear parts are manufactured from an iron-based material, typically by casting. The castings include arrays of cavities into which inserts from a wear resistant material (e.g., an iron-based metal alloy with a relatively high carbon content) are inserted.

In this current solution, an additional material such as an adhesive may be used to retain the inserts in the cavities. In practice, the insert is placed in the cavity, and the adhesive is provided around the insert.

### SUMMARY OF THE INVENTION

An object underlying the present invention is to provide a wear part which can be manufactured in an efficient way, while providing for a reliable fixation of the individual materials of the wear part to one another.

To achieve this object, the present invention provides in a first aspect a method for manufacturing a wear part according to the independent claim 1.

The claimed method entails, in a broad sense, the placement of retainers within the sockets formed in or on the body, alongside with the inserts. By means of the retainers, the wear resistant inserts are mechanically retained in the sockets, ideally without any adhesive.

The claimed method comprises the steps of providing a body comprising at least one socket formed in or on the body, and providing at least one insert of a wear resistant material configured to be received by the socket.

The body defines the general structure of the wear part and can be shaped differently depending on the intended use of the wear part. The body may be a wear component which is reinforced by means of the one or more wear resistant inserts.

The material of the body may be a metal material. For example, the body may be made of an iron based (Fe>50%) material including a relatively small amount of metal carbides, preferably less than 10%. Further examples of the material are steel, more particularly manganese steel. The body can be formed by any suitable manufacturing method. In a practical implementation, the body is formed by casting.

The one or more sockets provide structural support for the wear resistant inserts. The sockets can be provided as cavities or cut-outs recessed from a surface of the body, or as an otherwise shaped element formed in or on the body providing support for the wear resistant insert. Each socket extends along a longitudinal axis and may be generally defined by one or more sidewalls extending along said axis, and by a floor. Each socket may be opened towards a surface of the body at a position opposite to the floor along the longitudinal axis. The surface to which the socket is opened may be a wear surface, i.e., a surface of the body that is most exposed to wear and deterioration.

The one or more sidewalls and the floor of a socket may be integrally formed. In other words, the socket may be opened only towards a single surface of the body, such as the wear surface. In still other words, the socket may be accessible from one side of the body only, while being inaccessible from all further sides thereof.

In an exemplary practical implementation, the wear part may be intended to be used in equipment for reducing the size of material. The wear part may thus be implemented as a crusher component. The crusher component may be attached to supporting surfaces or frames acting as a mounting base of stone crushers, such as gyratory crushers, cone crushers, or jaw crushers.

The body of the crusher component forms a crushing body. More specifically, the crushing body may be a mantle for a gyratory or cone crusher, or a jaw plate or jaw die of a jaw crusher. The crushing body comprises a crushing surface which, during operation, comes into contact with material to be crushed. The crushing surface corresponds to the wear surface as previously described. One or more sockets are formed in or on the crushing body which receive one or more wear resistant inserts. The sockets may be cavities recessed from said crushing surface, the cavity being opened towards the crushing surface, wherein the cavity is defined by one or more sidewalls and a floor, wherein the floor and the one or more sidewalls (21) of the cavity are integrally formed.

The wear resistant insert is a structural component formed of a material having a higher hardness than the body. In this way, it is more resistant to wear than the body and thus forms a reinforcement structure of the body. The service life of the wear part can thus be prolonged by reducing wear on the body.

The wear resistant material of the insert may be a hardened material. The hardened material may comprise a hardness of more than 50 HRC, more than 52 HRC, or even more than 54 HRC. The wear resistant material may be a metal material, such as a steel alloy. For example, the insert may be made of an iron-based metal alloy having a carbon content. The carbon content may be more than 0.5% by weight, more than 0.8% by weight, more than 1% by weight, or even more than 1.2% by weight.

The wear resistant insert extends along a longitudinal axis between a first and second end. The shape of the wear resistant insert is not specifically limited and may, for example, be cylindrical, cuboidal, oval, oblong, or cubic. A peripheral surface of the insert surrounding the longitudinal axis may, for example, be round, flat, or be generally round with one or more flattened portions, without being limited to these examples.

In practical embodiments, the socket and the wear resistant insert have a corresponding shape, such that the wear resistant insert can be received by the socket. To facilitate this, the socket may be formed with slightly larger dimensions in a direction perpendicular to the longitudinal axis than the wear resistant insert. Dimensions of the socket and of the insert in a direction along the longitudinal axis may be substantially the same.

In this way, the insert can be fully received by the socket and, once received therein, one end surface of the insert along its longitudinal axis may rest against the floor of the socket or may be spaced at a distance therefrom. Spacers, rigid or compressible, may be arranged between this one end surface of the insert and the floor of the socket. The opposite end surface of the insert may be substantially flush with the surface of the body to which the socket is opened (e.g., the wear surface of the body), or may be positioned slightly below or above the wear surface.

The insert is received by the socket by insertion of the insert along an insertion direction. The insertion direction may be substantially parallel to the longitudinal axes of the insert and of the socket. In a partially or fully inserted state, a gap is formed between the insert and the body.

The method further comprises the step of retaining the wear resistant insert in the socket by means of a retainer.

The retainer is provided to join the insert to the body in a state in which the insert is received by the socket. Once located in the gap between the insert and the body, the retainer provides a retaining force which prevents the insert from falling out of the sockets and falling off from the body during use of the wear part.

The retainer may comprise a first retaining component only, or may comprise several retaining components, such as a first and a second retaining component, as will be further described below.

The first retaining component may be formed of a metal material, such as of steel, carbon steel, or mild carbon steel. However, the first retaining component may also be formed of any other material having a material hardness which is less than the hardness of the wear resistant insert and/or of the body.

In the method according to the present invention, the wear resistant insert is at least partially inserted into the socket along an insertion direction, such that the gap between the wear resistant insert and the body is formed. The insertion direction is parallel to the longitudinal axes of the insert and the socket. It may be advantageous that the insert is fully inserted into the socket, such that a floor of the socket comes into contact with a surface of the insert. In a subsequent step, the first retaining component is at least partially inserted in the gap.

The method further comprises the step of retaining the wear resistant insert in the socket by means of the retainer. The first retaining component is at least partially inserted in the gap between the wear resistant insert and the body in a state in which the wear resistant insert is at least partially received by the socket. A retaining force is provided by the retainer upon application of a force on the first retaining component and/or on the wear resistant insert, to thereby retain the wear resistant insert in the socket.

According to the method of the invention, the wear resistant insert is retained within the socket and joined to the body without employing the use of adhesives or resins. With the method according to the present invention, the wear part can be manufactured in a time-efficient manner while reducing costs, such as manufacturing costs and/or labour-costs.

Upon application of the force, the wear resistant insert is retained in the socket and thereby joined to the body. More specifically, after application of the force, the insert is retained in the socket through the retaining force acting between the wear resistant insert and the retainer, and/or between the retainer and the body. That is, prior to application of the force, the wear resistant insert may not be reliably retained within the socket of the body.

The force applied on the first retaining component and/or on the wear resistant insert may be an external force. In the present context, “external force” may refer to a force applied from outside of the wear part on the first retaining component and/or on the wear resistant insert, for example, by a human operator or a manufacturing apparatus.

While in practical embodiments the force is applied (directly) onto the first retaining component, the force may also be (indirectly) applied onto further retaining components of the retainer via the first retaining component and/or via the wear resistant insert.

Following from the above, the retainer provides a way of mechanically joining or attaching the insert to the body. A “mechanical joint” or “mechanical attachment” in the present context may include an adhesive-free attachment or joint, including a friction fit, a form fit, an interference fit, a press-fit, or combinations thereof.

For example, after application of the force, the retainer provides a frictional force between the insert and the body which is sufficiently high to prevent the insert from being released from the body during use of the wear part. Depending on the specific configuration of the body, the socket, the insert and the retainer, the mechanical joint may additionally or alternatively include a form fit, an interference fit, a press-fit, or combinations thereof.

The mechanical joint previously described may either be provided by a retaining force acting directly between the body and the insert, or by a retaining force acting via the retainer, i.e., between the insert and the retainer and between the retainer and the body.

The force may be applied on the first retaining component along the insertion direction along which the insert is received, i.e., inserted, into the socket, or along a direction parallel thereto.

The force applied on the wear resistant insert may be a torque causing rotation of the wear resistant insert around its longitudinal axis. To facilitate application of a torque on the insert, for example, indents, dimples, slits or an otherwise shaped reception for a tool may be formed on a surface of the insert.

As to the retention of the wear resistant insert in the socket, the retaining force provided by the retainer restricts relative translatory movement (i.e., relative movement along the longitudinal axis of the insert) between the wear resistant insert and the body. Once the retaining force is established by the retainer, substantially any translatory movement of the insert with respect to the body under normally occurring loads acting thereon during use of the wear part is prevented. Therefore, the wear resistant insert can be reliably held within the socket during and throughout use of the wear resistant component or construction.

While relative translatory movement is prevented by the retainer, relative rotary movement (i.e., a relative movement around the longitudinal axis of the insert) between the insert and the body may or may not be prevented by the retainer.

Application of the force on the first retaining component and/or on the wear resistant insert may have an effect of further inserting the first retaining component into the gap between the wear resistant insert and the body. That is, the first retaining component may be driven directly (via exertion of external force thereon) or indirectly (via application of external force on the wear resistant insert) further into the gap. The first retaining component thus travels further towards the floor of the socket.

The further the first retaining component is inserted or driven into the gap, as previously described, the greater the retaining force retaining the insert within the socket. The force may thus be applied until the wear resistant insert is securely held in the socket and/or until no further insertion of the first retaining component is possible, i.e., until the retaining force provided by the retainer is great enough for retaining the insert in the socket during use of the wear part.

Accordingly, this arrangement allows providing the retaining force in a desirable level. An increased retaining force may thus be provided for applications in which loads acting on the body and on the inserts are higher than normal, while a reduced retaining force may be provided for applications where loads acting on the body and the inserts are lower than normal, or where material characteristics of the insert, the retainer, or the body prescribe a certain limit for a maximum retaining force.

The level of external force applied on the first retaining component and/or the wear resistant insert may be used as an indicator for determining the retaining force.

In some embodiments, the retainer deforms upon application of the force on the first retaining component and/or on the wear resistant insert. The amount of deformation of the retainer affects the retaining force. That is, the higher the level of external force applied, the greater the amount of deformation of the retainer, and, in turn, the greater the retaining force provided by the retainer.

The deformation of the retainer may include plastic and/or elastic deformation.

Deformation of the retainer may be caused indirectly through application of the force, namely by compression of the retainer between the insert and the body. In other words, compressive forces acting in a direction perpendicular to the longitudinal axis of the insert and of the socket may cause deformation of the retainer. In further embodiments, the retainer may be deformed through application of the force, leading to an expansion or enlargement of the retainer.

In one practical embodiment, the first retaining component is a deformable component. In embodiments, the first retaining component may be deformable so as to expand or enlarge in at least one direction upon application of a force thereon. In other words, after application of a force on the expandable component, at least one dimension of the expandable component in a predetermined direction is greater than prior to application of the force. In the process of expanding or enlarging in the at least one dimension, the expandable component may reduce in size in another dimension.

The deformable component is inserted into the gap between the wear resistant insert and the body. Upon application of the force, the deformable component deforms and expands or enlarges, e.g., in a radial direction or a direction perpendicular to a longitudinal axis thereof, to thereby fill or bridge the gap between the insert and the body in a direction perpendicular to the longitudinal axis of the insert. Once the deformable component has expanded, it is in contact with a surface of both the insert and the body. The deformable component thereby urges the insert against another surface of the body or against a surface of an additional retainer, such that in turn a retaining force is provided which retains the insert in the socket.

The shape of the insert and/or the socket can be adapted in various ways to improve the fit and retention of the insert in the socket. For example, a ridge, a groove, or a flattened portion could be provided to the insert and/or to the socket.

As to the structural configuration of the deformable component, it may comprise a shaft and an expandable base. Upon application of the force on the shaft, the shaft and the expandable base are moved against each other, causing the expandable base to expand or enlarge. To facilitate expansion of the expandable base, it may comprise a first and second leg which are attached to each other at a tip so to adopt a “V” shape. The shaft is arranged such that it relatively moves in between the flanks of the “V” shaped expandable base, thereby causing the flanks of the expandable base to deflect outwards. The flanks deflect outward in opposed directions, i.e., in directions forming an angle of about 180° between each other.

The expandable base may adopt any other shape, suitable to expand upon movement of the expandable base and the shaft against each other. For example, the expandable base may also adopt a “C”-shape or “U”-shape.

The shaft and the expandable base may be structurally connected to each other at a juncture. The juncture may constitute a predetermined breaking point. Upon application of the force, the deformable component may break at the predetermined breaking point, allowing the shaft and the expandable base to be moved against each other.

Thereby, handling of the deformable component prior to insertion into the gap between the insert and the body, and the process of insertion into the gap is promoted.

In this practical embodiment, the insert may comprise a flattened portion on an otherwise round or partially round peripheral surface. The flattened portion is positioned on the insert such that the expandable base of the deformable component, once expanded, comes into contact with the flattened portion.

Accordingly, the surface contact between the expandable base and the peripheral surface of the insert can be increased, such that larger (retaining) forces can be transferred via the surface contact.

The socket may comprise a groove formed on the one or more sidewalls thereof, such that the gap between the insert and the body is of sufficient size to allow insertion of the deformable component. The deformable component may thus be inserted into the gap which is at least partially defined by the groove formed on the one or more sidewalls of the socket. For example, the groove extends straight along the longitudinal axis of the socket.

In another practical embodiment, the retainer comprises the first retaining component and a second retaining component.

The second retaining component is provided in the gap between the wear resistant insert and the body. In particular, the second retaining component may be inserted into the socket prior to insertion of the wear resistant insert, and prior to insertion of the first retaining component. The step of retaining the insert in the socket by means of the retainer may thus encompass inserting the second retaining component in the socket, at least partially inserting the wear resistant insert in the socket, and at least partially inserting the first retaining component in the gap between the insert and the body, and providing the force on the first retaining component to provide a retaining force to thereby retain the wear resistant insert in the socket.

In this case, the force may be directly applied onto the first retaining component, while the force indirectly acts on the second retaining component via the insert. Upon application of the force, the second retaining component is jammed between the insert and the body and may deform under this load. During application of the force on the first retaining component, it may or may not deform as a consequence of the compressive forces acting in a direction perpendicular to the longitudinal axis of the insert.

The wear resistant insert may be clamped or held in a press-fit between the first and second retaining component. The first and second retaining components are in turn clamped or held within the gap in a press-fit between the insert and the body.

The first retaining component may be inserted into the gap between the insert and the body at a position diametrically opposed to the second retaining component with respect to the insert.

The first retaining component may comprise one or more shims of a first material, and the second retaining component may comprise one or more shims of a second material.

The shims of the second retaining component may be shaped to fit within the gap between the insert and the body. The thickness of the shims of the second retaining component (i.e., their dimension in a direction perpendicular to longitudinal axes of the insert and the socket) may be constant or tapering. The shims of the second retaining component may be provided in the gap with the greater thickness side arranged towards the floor of the socket. When the shims of the second retaining component are arranged in the gap, a thickness of the shims increases in an insertion direction of the insert (i.e., the thickness of the shims increases in a direction from the opening towards the floor of the socket).

The one or more shims of the first retaining component may have a thickness (i.e., a dimension in a direction perpendicular to longitudinal axes of the insert and the socket) which is slightly oversized with respect to a corresponding dimension of the gap, such that compressive forces in directions perpendicular to the longitudinal axis of the insert can be generated during insertion of the first retaining component into the gap and upon application of the force thereon. The shims of the first retaining component may also be sized to fit within the gap between the insert and the body individually, but may form a set of shims with a total thickness which is slightly oversized with respect to a corresponding dimension of the gap.

The thickness of the shims of the first retaining component may be constant or tapering. The tapering thickness facilitates initial insertion of the shims of the first retaining component into the gap between the insert and the body with the tapered end of the shims, while the taper allows to generate compressive forces in directions perpendicular to the longitudinal axis of the insert upon application of the force thereon.

The shims of the first retaining component may be inserted into the gap with the tapered thickness side first. When the shims of the first retaining component are arranged in the gap, a thickness of the shims decreases in an insertion direction of the insert (i.e., the thickness of the shims decreases from the opening towards the floor of the socket).

The shims of the first and the second retaining component may be formed as sleeves conforming to an outer geometry of the insert and/or to a geometry of the gap between the insert and the body. The sleeves may partially surround the wear resistant insert.

The first material may be a metal, such as steel, copper, or aluminium, a metal alloy, such as brass, or a polymer material, such as plastic. The second material may be the same or a material different from the second material. For example, the second material may be a different metal, a different metal alloy or a different polymer material. The first and second material may also be formed of any other materials having a lower material hardness than the hardness of the wear resistant insert and/or of the body.

In practical embodiments, the first material may have a material hardness which is greater than the hardness of the second material. For example, the first material may be steel and the second material may be copper.

In a still further practical embodiment, the first retaining component comprises one or more of substantially spherical members. The one or more spherical members may be formed of a metal material, such as steel. The one or more spherical members may however be formed of a different material having a lower material hardness than the hardness of the wear resistant insert and/or of the body.

In this embodiment, one or more grooves are formed on the one or more sidewalls of the socket, the grooves being recessed from a surface of the sidewall with a depth. The groove may be spirally formed while extending along the longitudinal axis of the socket from the edge defined between the socket and the surface of the body to which the socket is opened towards the floor of the socket. The spiral groove at least partially surrounds the insert about its longitudinal axis, when the insert is inserted into the socket.

The groove may also be formed differently, so long it comprises a portion extending in a direction different from the direction along the longitudinal axis, so as to at least partially surround the wear resistant insert about its longitudinal axis, when the insert is in an inserted state.

A maximum distance along a direction perpendicular to the longitudinal axis of the wear resistant insert and the socket between the groove and a peripheral surface of the wear resistant insert decreases towards the floor of the socket. For example, the depth of the groove decreases towards the floor of the socket.

After (at least partially) inserting the insert into the socket, the one or more spherical members are inserted into the gap between the insert and the body. More specifically, the one or more spherical members are received by the groove formed on the sidewall of the socket, as described above.

Upon application of the force on the wear resistant insert, the one or more spherical members travel along the groove towards the floor of the socket and/or in a circumferential direction of the insert. Due to the decreasing distance between the groove and the peripheral surface of the insert, the one or more spherical members are jammed between said insert and body, and may deform under the resulting compressive load. The one or more spherical members thereby provide a retaining force which retains the insert in the socket.

In a second aspect, the present invention provides a wear part as defined in the second independent claim.

The wear part comprises a body comprising at least one socket formed in or on the body, at least one insert of a wear resistant material configured to be received by the socket, and a retainer configured to retain the wear resistant insert in the socket.

The retainer comprises a first retaining component configured to be at least partially inserted within a gap between the wear resistant insert and the body in a state in which the wear resistant insert is at least partially received by the socket, wherein the retainer is configured to provide a retaining force upon application of a force on the first retaining component and/or on the wear resistant insert, to thereby retain the wear resistant insert in the socket.

The wear part according to the present invention can be manufactured more efficiently in terms of time and costs. Moreover, the wear part does not comprise adhesives or resins for retaining the inserts in or on the body. Hence, the present invention circumvents the risks which need to be observed when handling or using adhesives or resins.

Where applicable and unless stated otherwise, the previous description with respect to the method for manufacturing of the wear part applies mutatis mutandis to the wear part described hereinafter. Moreover, the following description applies, where applicable, to the method for manufacturing of the wear part.

The retainer may be configured to provide the retaining force to restrict relative translatory movement between the wear resistant insert and the body, to retain the wear resistant insert in the socket. The retainer may be additionally configured to restrict relative rotary movement between the insert and the body around the longitudinal axis of the insert. However, relative rotary movement may not necessarily be restricted by the retainer.

The retainer may be configured to mechanically join the wear resistant insert and the body to each other upon application of the force on the first retaining component and/or on the wear resistant insert, the mechanical joint being a friction fit, a form fit, an interference fit, a press-fit, or combinations thereof.

The first retaining component may be configured to be further inserted into the gap between the wear resistant insert and the body by applying the force on the first retaining component and/or on the wear resistant insert.

The socket may be configured to receive the wear resistant insert by inserting the wear resistant insert along an insertion direction into the socket, and the retainer may be configured to provide the retaining force upon application of the force on the first retaining component of the retainer along the insertion direction or a direction parallel thereto.

The wear resistant insert may be configured to receive a torque causing rotation of the wear resistant insert around its longitudinal axis.

The retainer may be configured to deform upon application of the force on the first retaining component and/or on the wear resistant insert to provide the retaining force to thereby retain the wear resistant insert in the socket.

The retainer may be configured to deform by being compressed between the wear resistant insert and the body.

In one practical embodiment where the first retaining component is the deformable component, such as the anchor pin, the deformable component is configured to expand upon application of the force thereon, to provide the retaining force to thereby retain the wear resistant insert in the socket.

In another practical embodiment, where the retainer comprises the first retaining component and the second retaining component, the second retaining component is configured to be provided in the gap between the wear resistant insert and the body. The second retaining component may be configured to deform upon application of the force on the first retaining component.

In a still further practical embodiment, where the first retaining component comprises one or more of substantially spherical members, the one or more spherical members may be configured to deform upon application of the force on the wear resistant insert.

### BRIEF DESCRIPTION OF THE DRAWINGS

The above, as well as additional objects, features and advantages of the present invention will be better understood through the following illustrative and non-limiting detailed description of embodiments of the present invention, with reference to the appended drawings, where the same reference numerals will be used for similar elements, wherein:

FIG. 1(a) is a schematic cross-sectional view of a wear part according to the present invention,

FIG. 1(b) is a side view of a crusher component of a gyratory or cone crusher as one implementation of a wear part according to the present invention,

FIG. 2(a) schematically illustrates a retainer according to a first embodiment of the present invention prior to application of a force thereon,

FIG. 2(b) schematically illustrates the retainer of FIG. 2(a) in a deformed state, after application of the force thereon,

FIG. 2(c) is a top view that schematically illustrates the arrangement of two anchor pins between an insert and a surrounding body,

FIG. 2(d) schematically illustrates a wear resistant insert comprising a flattened surface according to an embodiment of the present invention,

FIG. 3(a) schematically illustrates a first retaining component of a retainer according to a second embodiment of the present invention,

FIG. 3(b) schematically illustrates a second retaining component of the retainer according to the second embodiment of the present invention,

FIG. 3(c) is a cross-sectional schematic view of a wear resistant insert and a first configuration of shims within a socket of a body,

FIG. 3(d) is a cross-sectional schematic view of a wear resistant insert and a second configuration of shims within a socket of a body,

FIG. 3(e) is a cross-sectional schematic view of a wear resistant insert and a third configuration of shims within a socket of a body,

FIG. 3(f) is a top view that schematically illustrates the arrangement of three shims between an insert and a surrounding body,

FIG. 4(a) is a cross-sectional view of a socket formed in the body with a spirally formed groove on a sidewall of the socket according to a third embodiment of the present invention, and

FIG. 4(b) illustrates a working principle of retaining a wear resistant insert in the socket of FIG. 4(a) by means of a retainer comprising one or more spherical members according to the third embodiment of the present invention.

### DETAILED DESCRIPTION

### Wear Part

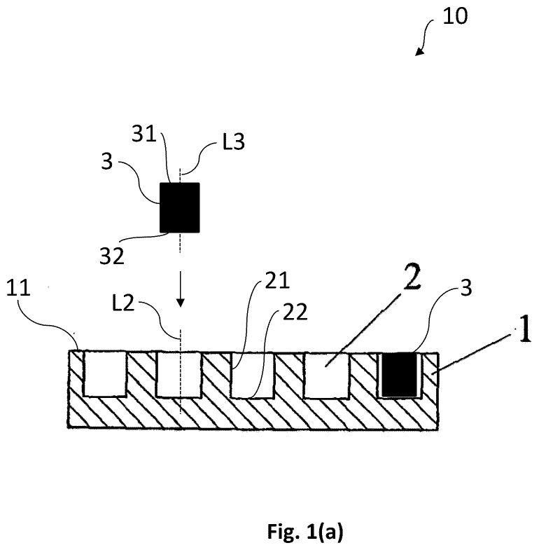

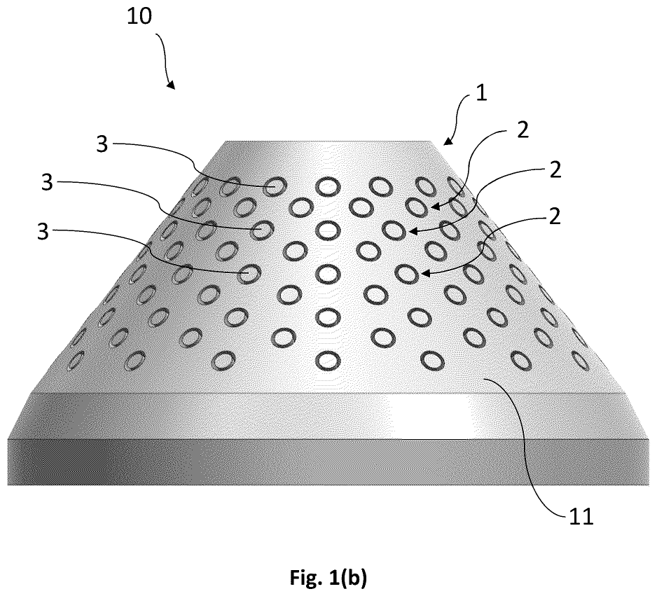

FIG. 1(a) is a cross-sectional view that schematically illustrates a wear part 10 according to the present invention.

The wear part 10 comprises a body 1 formed of a basic material. The wear part 10 has a wear surface 11. A plurality of sockets 2 are formed in the body 1 so as to extend from the wear surface 11 into the material of the body 1. Each socket 2 is defined by one or more sidewalls 21 and a floor 22 and extends along a longitudinal axis L2.

In the exemplary embodiment of FIG. 1(a), the sockets 2 are provided as cavities recessed from the wear surface 11 of the body 1, wherein the cavities are open at one end as seen along the longitudinal axis L2 and closed at the other end.

The sockets 2 in the body 1 are configured to receive inserts 3 of a wear resistant material. The wear resistant inserts 3 are formed of a material that has a greater hardness than the basic material forming the body 1. In this way, the wear resistant inserts exhibit a higher resistance against wear than the body 1. Each wear resistant insert 3 extends along a longitudinal axis L3 between a first or upper surface 31 and a second or lower surface 32 of the insert 3.

In practical embodiments, the wear resistant inserts 3 have a shape corresponding to that of the sockets 2 receiving the insert 3. The shape of the wear resistant insert 3 is not specifically limited. In one practical implementation, cylindrical inserts 3 would be used. The inserts may, for example, also have a cuboid, cubic, oblong, or oval shape, however, without being limited thereto. The sockets 2 and inserts 3 are respectively dimensioned such that the inserts 3 can be received within the sockets 2.

The height of the insert 3 between the upper and lower surfaces 31, 32 may be identical with the longitudinal extension of the socket 2 from the floor 22 to the wear surface 11, but ideally the height of the insert 3 along the axis L3 is slightly less than the height of the socket 2 along the axis L2 so that the upper surface 31 of the insert 3 ends up below the wear surface 11 when the insert 3 is fully received in the socket 2. In further embodiments, the height of the insert 3 along the axis L3 may be slightly greater than the height of the socket 2 along the axis L2 so that the upper surface 31 is positioned slightly above the wear surface 11 in the fully received state.

To join the wear resistant inserts 3 to the body 1, each insert 3 is inserted into a corresponding socket 2 from the side of the wear surface 11 of the body 1. The insert 3 is inserted into the socket 2 along an insertion direction (as depicted by the arrow in FIG. 1(a)). The insertion direction is substantially parallel to the longitudinal axes L2 and L3 of the socket 2 and the insert 3, respectively.

To facilitate inserting the inserts 3 into the sockets 2, a dimension of each of the sockets 2 in a direction perpendicular to the longitudinal axis L2 may be formed to be slightly larger than a dimension of the inserts 3 perpendicular to the longitudinal axis L3. For example, if the sockets 2 and inserts 3 have a cylindrical shape, an outer diameter of an insert 3 is smaller than an inner diameter of the corresponding socket 2. A gap is thus formed between the outer periphery of the insert 3 and the inner periphery of the socket 2 in the body 1 in a fully or at least partially inserted state of the insert 3.

Once the insert 3 has been fully inserted into the socket 2 of the body 1 (as illustrated for the socket 2 on the right-hand side in FIG. 1(a)), the lower surface 32 of the insert 3 rests on and contacts the floor 22 of the socket 2. In the fully inserted state, the top surface 31 of the insert 3 may be substantially flush with the wear surface 11 of the body, but ideally it is below the wear surface 11 of the body, as explained above. In further embodiments, the top surface 31 of the insert 3 may also be slightly above the wear surface 11 in the fully inserted state.

In the state in which the insert 3 is fully inserted into the socket 2 of the body 1, the lower surface 32 does not necessarily lie against the floor 22 of the socket 2, but may be arranged at a distance thereto. Spacers, rigid or compressible, may be provided and arranged between the floor 22 of the socket 2 and the lower surface 32 of the insert 3.

Once inserted into the sockets 2, the inserts 3 provide a reinforcement to the body 1 which is advantageous to reduce wear of the body 1 and/or to prolong service life of the wear part 10.

FIG. 1(b) illustrates a mantle 10 for a gyratory or cone crusher as one possible implementation of the wear part according to the present invention. Other possible implementations of the wear part according to the present invention include a jaw plate or jaw die of a jaw crusher which is not specifically illustrated.

In a practical implementation, the mantle 10 is cast from steel, such as manganese steel. During operation, a wear surface 11 of the mantle 10 comes into contact with material to be crushed during operation of the crusher: In a manner known per se, the mantle 10 is mounted within the crusher so that a crushing gap is formed between the mantle 10 and an opposite stationary or moving element of the crusher. Rocks, stones, or other materials are introduced into the crushing gap and pressed between the wear surface 11 of the mantle 10 and the opposite surface within the crusher to thereby break apart the material to be crushed.

During this crushing operation, significant forces are exerted upon the mantle 10, resulting in a significant wear of the mantle 10 and other wear parts. To provide a reinforcement to the mantle 10 for reducing wear on and/or prolonging service life of the mantle 10, wear resistant inserts 3 are embedded into the wear surface 11 of the mantle 10. The inserts 3 are received in sockets 2 formed in the mantle 10 as just described with reference to FIG. 1(a). The inserts 3 are retained in the sockets 2 of the mantle 10 with the upper surfaces 31 of the inserts 3 substantially flush with, below, or above the wear surface 11 of the mantle 10.

In the embodiment of FIG. 1(b), the sockets 2 retaining the wear resistant inserts 3 are arranged in multiple rows about the periphery of the mantle 10 in an area of the wear surface 11 which is most exposed to wear. The sockets 2 in adjacent rows are offset relative to one another. Many other patterns of sockets 2 and corresponding inserts 3 are possible though.

The present invention provides a novel way of joining the wear resistant inserts 3 to the body 1 of a wear part as schematically illustrated in FIG. 1(a), such as a mantle 10 as shown in FIG. 1(b), a jaw plate or jaw die, or any other wear part: each insert 3 is retained within the corresponding socket 2 by means of one or more retainers that are provided in a gap between the outer periphery of the insert 3 and the surrounding inner periphery of the corresponding socket 2 in the body 1. A retaining force is provided by the retainer(s) to retain the insert 3 within the socket 2 and prevent, or substantially prevent, any relative movement of the insert 3 in the socket 2. The invention thereby provides a way of mechanically joining or attaching the inserts 3 to the body 1. Exemplary embodiments of retainers will be described further below. By way of the retainer(s), the wear resistant inserts 3 are reliably held within the sockets 2 during use of the wear part 10, despite significant forces exerted thereon.

### First Embodiment

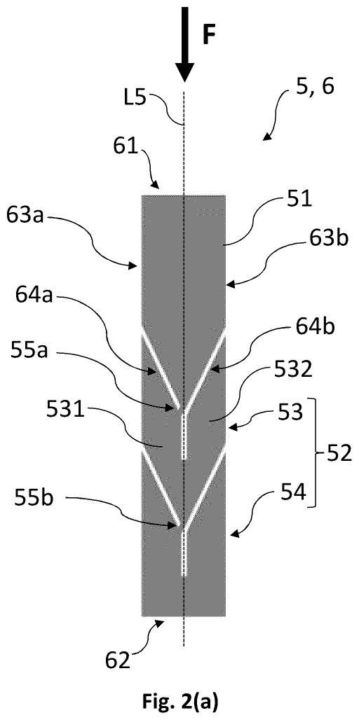

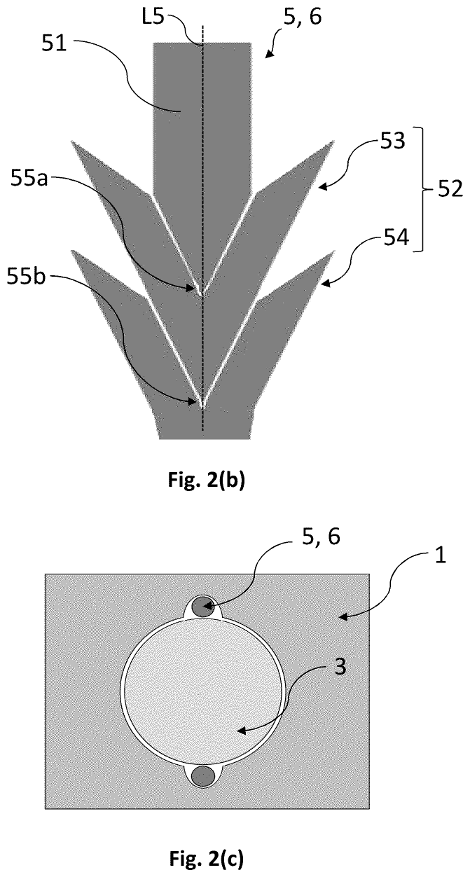

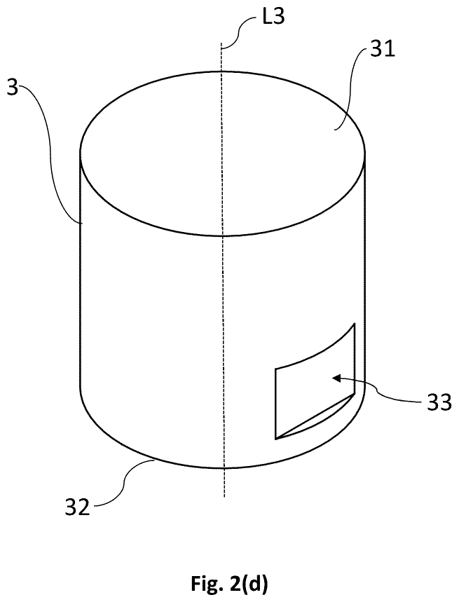

FIG. 2(a) and 2(b) illustrate a retainer 5 configured to retain a wear resistant insert 3 within a socket 2 of a body 1 as described above, in accordance with a first embodiment of the present invention. According to this exemplary embodiment, the retainer 5 has the form of an anchor pin or dowel 6.

In this embodiment, the anchor pin 6 is elongated along a longitudinal axis L5 between a first or upper end 61 and a second or lower end 62. The anchor pin 6 may have an essentially square or rectangular cross section, in which case an outer periphery of the anchor pin 6 is defined by pairs of opposite side walls 63. The anchor pin 6 comprises a shaft part 51 and an expandable part 52 which are arranged adjacent to each other along said longitudinal axis L5, with the shaft part 51 including the top end 61 and the expandable part 52 including the lower end 62 of the pin 6. The expandable part 52 is configured to expand in directions perpendicular to the longitudinal axis L5 when a force F is applied on the pin 6 along the longitudinal axis L5. More specifically, upon application of the force F on the upper end 61 of the pin 6 while the lower end 62 thereof is supported, the shaft part 51 and the expandable part 52 are moved against each other, resulting in a deformation and expansion of the expandable part 52.

As illustrated in FIG. 2(a), the expandable part 52 of the anchor pin 6 has a pattern of slits extending at angles from two opposite side walls 63a, 63b of the anchor pin 6. One possible pattern of slits is described below with respect to one practical embodiment, without limiting the invention thereto.

In this embodiment, two respective pairs of slits are arranged in “Y” shaped patterns. Each “Y” shaped pattern is comprised of a first slit 64a extending from a first sidewall 63a of the pin 6 at an angle towards the lower end 62 of the pin 6, and a second slit 64b extending from an opposite, second sidewall 63b of the pin 6. A first, outer section of the second slit 64b is also at an angle towards the lower end 62 of the pin 6. In the present embodiment, the angle that this outer section 64b forms with the longitudinal axis of the pin 6 is identical in magnitude with the angle that the first slit 64a forms with the longitudinal axis of the pin 6, but is angled in the opposite direction away from the longitudinal axis L5. A second, inner section of the second slit 64b extends along the longitudinal axis L5 of the pin 6 towards the lower end 62 of the pin 6. The first 64a and second slits 64b of the pair do not entirely penetrate the pin 6 but leave a juncture 55a between them.

In this embodiment, two identical “Y” shaped patterns of slits are formed in the pin 6. In other embodiments, only one “Y” shaped pattern or more than two “Y” shaped patterns could be provided.

The “Y” shaped slits create two expandable sections 53 and 54 of the pin 6, staggered adjacent the lower end 62 of the pin along the longitudinal axis L5 thereof. Each expandable section 53 and 54 is essentially “V” shaped and comprises a first leg 531 and a second leg 532. The first V-shaped expandable section 53 is arranged with respect to the shaft part 51 such that the shaft part 51 is pushed between the legs 531 and 532 when the said force F is applied on the pin 6. The second V-shaped expandable section 54 is arranged with respect to the first expandable section 53 such that an apex of the first expandable section 53 is pushed between the legs of the second expandable section 54 when the force F is applied. This causes the legs 531 and 532 of the first expandable section 53 to be spread outward in directions away from to the longitudinal axis L5. In particular, the legs 531 and 532 spread outward in opposite directions, creating attachment forces in opposite directions (180° apart). That feature creates high fastening forces, enough to keep the inserts in place during operation.

Likewise, upon application of the force F on the shaft end of the pin 6, the tip of the first expandable section 53 is relatively moved in between the flanks of the second expandable section 54, causing similar deformation as described with respect to the first expandable section.

In practical embodiments, the pin 6 is designed such that upon application of the force F, the expandable section 54 expands first, and the expandable section 53 expands subsequently. More generally, the one or more expandable sections are configured to expand according to their arrangement from the lower end 62 towards the upper end 61 of the pin 6, such that the expandable section located most towards the lower end 62 expands first, and the expandable section located most towards the upper end 61 expands last.

In this way, the expandable part 52 of the pin 6 expands in a direction away from the longitudinal axis L5, in particular perpendicular to the longitudinal axis L5. FIG. 2(b) illustrates the pin 6 with the expandable part 52 in the expanded state, after application of the force F to the upper end 61 of the pin 6. The dimension of the pin 6 in a direction perpendicular to the longitudinal axis L5 is greater than a dimension in said direction prior to deformation of the pin 6.

The working principle of the retainer 5 according to the first embodiment of the present invention is as follows: after an insert 3 has been inserted into a corresponding socket 2 formed in the body 1, an anchor pin 6 is inserted between the outer periphery of the insert 3 and the inner periphery of the socket 2, with a longitudinal axis L5 of the anchor pin 6 extending substantially in parallel with the longitudinal axes L2, L3 of the socket 2 and insert 3. A force F is then applied onto the anchor pin 6 in a direction along its longitudinal axis L5. This makes a section of the anchor pin 6 expand within the gap until the expanded section of the anchor pin 6 provides a tight interference fit between the outer periphery of the insert 3 and the inner periphery of the socket 2. In this way, a retaining force is provided that is sufficient to retain the insert 3 within the socket 2 during operation of the crusher.

The expandable part 52 of the pin 6 does not necessarily need to comprise “V” shaped expandable sections 53, 54. Any other shape causing expansion of one or more expandable sections once the shaft part 51 is relatively moved against the expandable part 52 can considered, such as, for example, a “U”-shape or a “C”-shape.

As a result of the pattern of “Y” shaped slits, the shaft part 51 and the expandable sections 53 and 54 of the pin 6 are structurally attached to one another at junctures 55a and 55b, as illustrated in FIG. 2(a) and 2(b). In this way, the pin 6 is formed as an integral component. Prior to application of the force F, relative movement of the individual sections with respect to each other is thus prevented. Thereby, handling of the pin 6 prior and during insertion into the gap between the insert 3 and the body 1 is enhanced.

Specifically, in the illustrated embodiment, the shaft part 51 of the pin 6 adjacent the expandable part 52 is tapered into a tip, and a first juncture 55a is between the tip of the shaft part 51 and a valley of the first expandable section 53. Upon application of the force F, relative movement of the shaft part 51 with respect to the first expandable section 53 results in the tip of the shaft part 51 being pushed further into the valley at the juncture 55a.

Much in the same way, a second juncture 55b is between a tip of the first expandable section 53 and an adjacent valley of the second expandable section 54. Upon application of the force F, relative movement of the first expandable section 53 with respect to the second expandable section 54 results in the tip of the first expandable section 53 being pushed further into the valley at the juncture 55b.

FIG. 2(b) illustrates the pin 6 in a deformed and expanded state and shows that the pin 6 actually broke at the junctures 55a and 55b, allowing for relative movement of the shaft part 51 with respect to the first expandable section 53, as well as for relative movement of the first and second expandable sections 53 and 54 that in turn resulted in the flanks 531, 532 of the first expandable section 53 and the flanks of the second expandable section 54 to spread in directions away from the longitudinal axis L5. Thus, the junctures 55a, 55b in this embodiment constitute predetermined breaking points.

The anchor pin 6 of this embodiment is a piece of mild carbon steel designed to fasten round inserts 3 into a body, specifically a casting 1. More generally, the pin 6 may be formed of any material with a lower material hardness than that of the body 1 and/or of the insert 3. For example, the pin 6 may be formed of another metal material, such as of aluminium or copper, of a metal alloy material, or even of a polymer material, such as of plastic. The anchor pin is designed to be fast and easy to fasten the inserts 3 in their position, replacing the usage of adhesives or other bonding materials.

This anchor pin 6 is used as follows to join an insert 3 to a body or casting 1.

FIG. 2(c) shows that the sockets 2 in this case are formed to accommodate cylindrical inserts 3, wherein the side walls of the sockets 2 are additionally recessed at two locations to provide space for two anchor pins 6 of the kind described above. The number of recesses, which can be different from two, corresponds to the number of anchor pins 6 provided for retaining the insert 3 within the socket 2.

After the anchor pins 6 have been inserted between the insert 3 and the body 1 and upon application of the force F on the pin 6, the V-shaped expandable sections 53, 54 of the expandable part 52 of the pin 6 are expanded and come into contact with an outer periphery of the wear resistant insert 3 and an inner periphery of the socket 2 formed in the body 1. More specifically, a first leg 531 of the first expandable section 53 and a first leg of the second expandable section 54 may come into contact with the outer periphery of the insert 3, whereas the second leg 532 of the second expandable section 54 and a second leg of the second expandable section 54 may come into contact with the inner periphery of the socket 2, or vice versa. In this way, the insert 3 is urged against a surface of the body 1 or against a surface of another retainer. The frictional force thus created prevents relative translatory movement (i.e., a relative movement along the longitudinal axes L2 and L3) of the insert 3 and the body 1 during and throughout use of the wear part 10.

The retainer 5 thus joins the insert 3 to the body 1 in a mechanical manner, i.e., by a mechanical joint, particularly by or at least including a friction fit. Depending on the particular configuration of the base 1, the socket 2, the insert 3, and the retainer 5, the mechanical joint may additionally or alternatively include a form fit, an interference fit, a press-fit, or combinations thereof.

Accordingly, the retainer 5 reliably retains the insert 3 within the socket 2, without the need of adhesives or resins. The anchor pin 6 can be installed in a time-efficient manner and be formed of a relatively inexpensive material.

Although one retainer 5 comprising the previously described anchor pin 6 is sufficient for retaining the insert 3 in the socket 2 throughout use of the wear part, more than one anchor pin 6 can be provided for retaining the wear resistant insert 3 within the socket 2.

FIG. 2(d) illustrates a wear resistant insert 3 comprising an at least partially rounded peripheral surface surrounding the longitudinal axis L3. The insert 3 comprises a flattened portion 33 on its otherwise at least partially rounded peripheral surface. The flattened portion 33 is provided and arranged to come into contact with the expandable part 52 of the pin 6, in particular with one or more flanks of one or more expandable sections.

The flattened portion 33 advantageously allows to increase the retaining force by increasing surface contact of the expandable part 52 of the pin 6 and of the peripheral surface of the insert 3. Thus higher forces can be transmitted via this surface contact.

The attachment provided by anchor pins 6 is recyclable, sustainable and safe. The anchor pins 6 improve the manufacturing process by reducing the handling of heavy parts, attaching the inserts faster and providing opportunities reducing overall costs.

### Second Embodiment

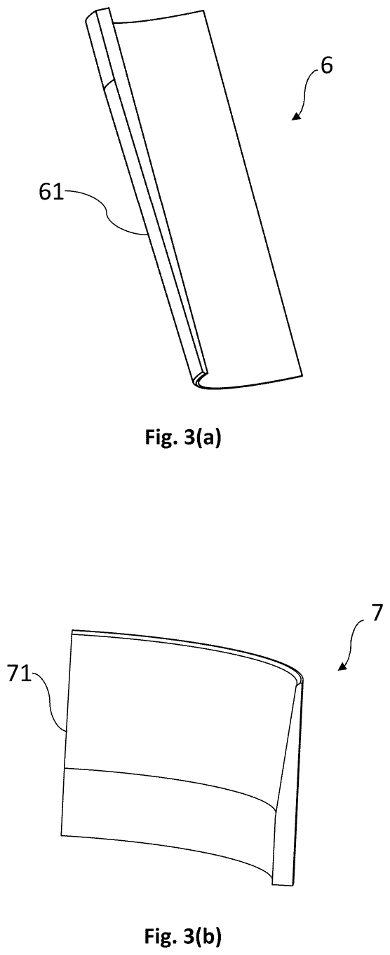

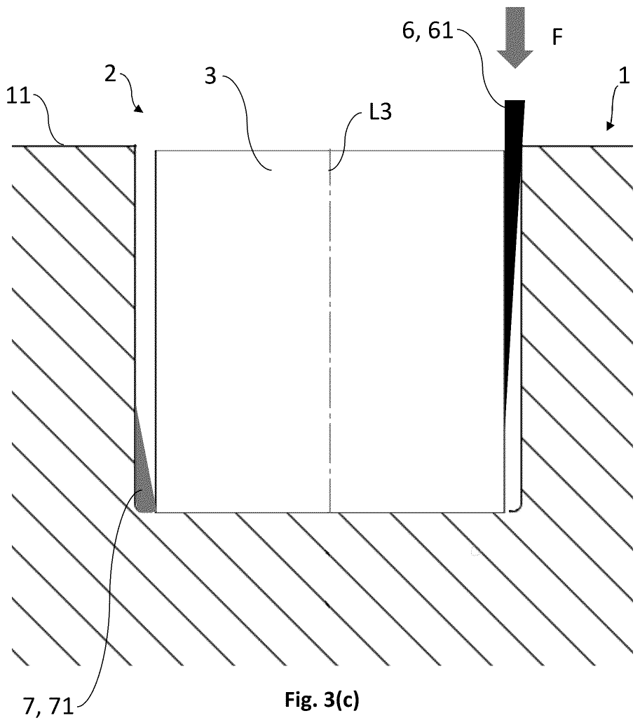

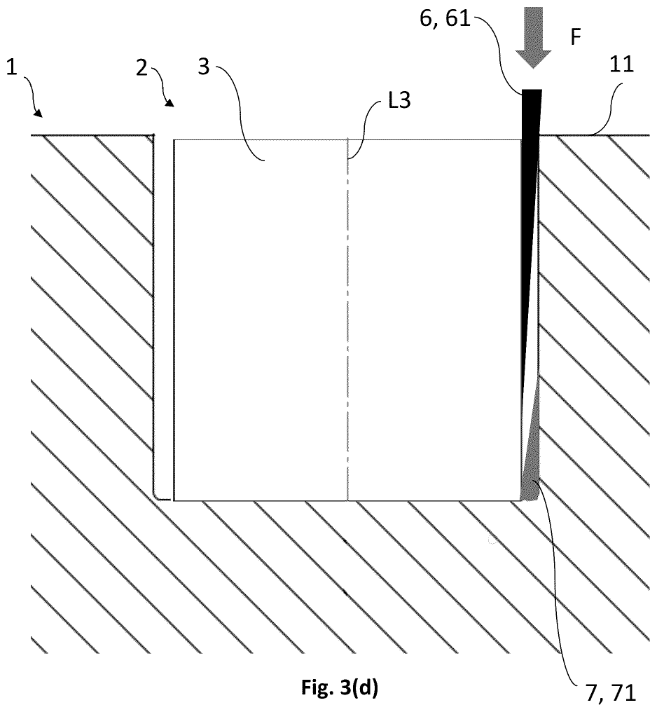

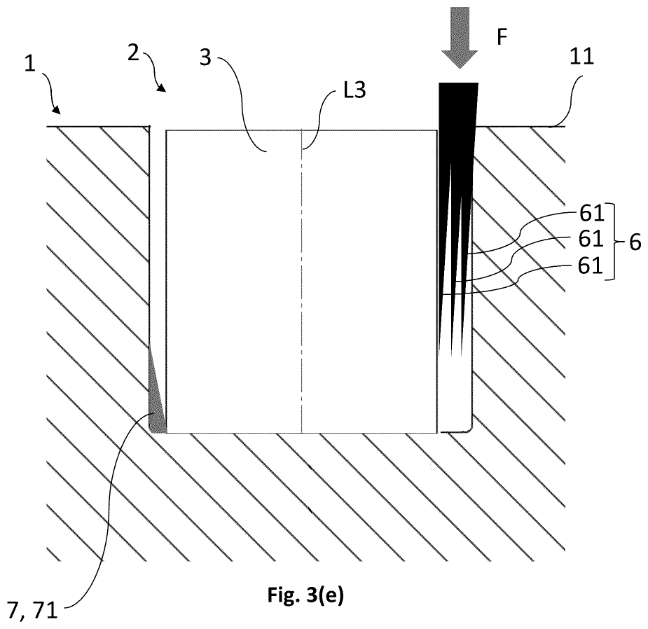

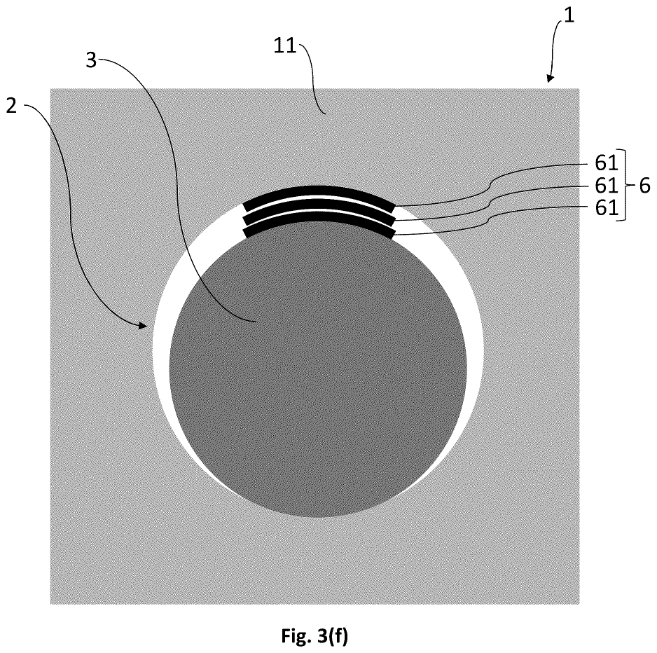

With reference to FIG. 3(a) to 3(f), a second embodiment for fastening inserts 3 within sockets 2 in a body or casting 1 will be described.

This embodiment relies, broadly speaking, on two kinds of shims that are placed between the outer periphery of an insert 3 and the surrounding inner periphery of a corresponding socket 2.

FIG. 3(a) schematically shows an exemplary shim 61 of the first kind. The shim 61 is formed from a sheet material that has a first or upper edge, a second or lower edge and two opposite side edges. In this embodiment, the upper and lower edges are shorter than the opposite side edges. The shim 61 is provided with a curvature so that the upper and lower edges are curved. The curvature of the shim 61 is adapted to the size and outer shape of the wear resistant insert 3.

In this embodiment, the shim has the same dimensions at its upper and lower edges. In other embodiments, the sheet forming the shim 61 may be cut into a specific predetermined shape, such that the shim 61 has different dimensions at the upper and lower edge. In some embodiments, the shim 61 is wider at the upper edge than at the lower edge. For example, the shim 61 may be cut into the shape of a “T” so that the shim is wider at the upper edge than at the lower edge.

The shim 61 is formed from a material that has a lower material hardness than the material of the wear resistant insert 3 and/or of the body 1. The shim 61 may be formed from a metal material, such as steel, copper, or aluminium, a metal alloy material, such as brass, or a polymer material, such as plastic.

FIG. 3(b) shows exemplary shims 71 of the second kind that can, but must not necessarily be used to complement the shims 61.

In the following, the aforementioned shims 61 of the first kind will thus be referred to as the “primary shims 61”, and the shims 71 of the second kind will be referred to as the “secondary shims 71” for simplicity.

Each secondary shim 71 is formed from a sheet material that has a first or upper edge, a second or lower edge and two opposite side edges. In this embodiment, the upper and lower edges of the secondary shim 71 are longer than the opposite side edges. The secondary shim 71 is provided with a curvature so that the upper and lower edges are curved. The curvature of the secondary shim 71 is adapted to the size and outer shape of the wear resistant insert 3.

Similar as the primary shim 61, the secondary shim 71 has the same dimensions at its upper and lower edge. In other embodiments, the secondary shim 71 may be cut into a specific predetermined shape, such that the secondary shim 71 has different dimensions at the upper and lower edge. In some embodiments, the secondary shim 71 is wider at the lower edge than at the upper edge. For example, the secondary shim 71 may be cut into the shape of a “T” so that the secondary shim 71 is wider at the lower edge than at the upper edge.

In this embodiment, the primary shims 61 and secondary shims 71 have approximately the same width, but the primary shims 61 are longer (the side edges thereof are longer) than the secondary shims 71. In further embodiments, for example if a longitudinal extension of the inserts 3 is relatively short, the primary shims 61 and the secondary shims 71 may also be of substantially the same length.

The secondary shim 71 is formed from the same material or a material that is different from the material of the primary shim 61. In practical embodiments, the secondary shim 71 is ideally formed from a material that has a lower material hardness than the material of the primary shim 61. For example, the primary shim 61 may be made from steel and the secondary shim 71 may be made from copper, wherein the copper material of the secondary shim 71 is softer than the steel material of the primary shim 61.

The shims 61 and 71 have a thickness that differs between the upper and lower edge. In the embodiment illustrated in FIG. 3(a) and (b), the primary shim 61 has a greater thickness at the upper edge than at the lower edge, while the secondary shim 71 has a greater thickness at the lower edge than at the upper edge.

The shims 61 and 71 each comprise a first portion with a constant thickness, and a second portion with a tapering thickness. The constant thickness portion of the primary shim 61 is located towards the first or upper edge, while the constant thickness portion of the secondary shim 71 is located towards the second or lower edge. In the tapering thickness portion, the thickness of the primary shim 61 decreases in a direction from the first or upper edge towards the second or lower edge. The thickness of the secondary shim 71 decreases in a direction from the second or lower edge toward the first or upper edge.

To retain an insert 3 within a socket 2 by way of such shims, the following steps are performed.

As a preparatory measure, the sockets 2, primary shims 61 and secondary shims 71 (if any) are cleaned with a degreasing agent such as acetone.

As explained further above, the use of secondary shims 71 is optional. The following steps are performed in case secondary shims 71 are used.

A secondary shim 71 is placed within a socket 2 so that the lower edge of the shim 71 is at or near the floor of the socket 2. The shim 71 is dimensioned so that it extends about a portion of the inner periphery of the socket 2: The shim 71 extends about a part of the circumference of the socket 2 that, for the shim 71 illustrated in FIG. 3(b), corresponds to about 90 degrees of the circumference, and extends about a part of the depth of the socket 2 that, for the shim 71 illustrated in FIG. 3(b), makes up less than half of the depth of the socket 2. In further embodiments, the shim 71 may be dimensioned to extend about a part of the circumference corresponding to less than or equal to 180 degrees of the circumference of the socket 2, for example to about 30, 60, 90, 120, 150, or 180 degrees.

The secondary shim 71 is placed in the socket 2 with its side having the greater thickness arranged towards the floor 22 of the socket 2 and with the tapered side arranged towards the opening of the socket 2 to the wear surface 11.

The radius of curvature of the shim 71 may be larger than the radius of curvature of the socket 2 so that the shim 71 does not contact the inner periphery of the socket 2 across the entire width of the shim 71 but only in the area of the side edges of the shim 71. In other embodiments, the radius of curvature of the shim 71 and of the inner periphery of the socket 2 may be substantially the same.

In a practical implementation of the wear part as a mantle 10 for a gyratory or cone crusher, when the mantle 10 is in an upright position, the sockets 2 extend essentially horizontally into the mantle 10, the floors 22 (i.e., the closed inner ends) of the sockets 2 extend in an essentially vertical direction, and a lower part of an inner periphery of each socket 2 can be considered a “bottom” of the socket 2. The shim 71 is placed on the bottom of the socket 2.

In some cases, one secondary shim 71 can be sufficient. In other cases, for example when the gap between the insert 3 and the body 1 is relatively large, two or more, essentially identical secondary shims 71 may be placed within the socket 2. The one or more additional secondary shims 71 may be placed on top of the initial secondary shim 71 or at another position within the socket 2 along the inner surface thereof, so that the lower edge(s) of the one or more additional shim(s) 71 is also at or near the floor of the socket 2.

The use of secondary shims 71 is optional, however. In practical implementations, 0, 1, 2, 3, or more than three secondary shims 71 may be provided. In a practical implementation, two secondary shims 71 may be used. The number of secondary shims 71 should be chosen so that the wear resistant insert 3 in the next step can still be pushed all the way to the floor of the socket 2.

A wear resistant insert 3 is placed into the socket 2 that may have been equipped with the optional secondary shim or shims 71, and is pushed to the floor 22 of the socket 2. The insert 3 is pushed all the way into the socket 2, optionally past the secondary shim(s) 71, until the insert 3 (the lower surface 32 thereof) firmly touches the floor 22 of the socket 2 and the top surface 31 of the insert 3 is not only flush with but even below the wear surface 11 of the wear part 10. In further embodiments, the lower surface 32 does not contact the floor 22 of the socket 2 when the insert 3 is fully received by the socket 2. Moreover, in further embodiments, the top surface 31 of the insert 3 may be positioned slightly above the wear surface 11 when the insert 3 is fully received by the socket 2.

To provide for the necessary fixation of the insert 3 within the socket 2, one or several of the aforementioned primary shims 61 shown in FIG. 3(a) are used. FIG. 3(c) and 3(d) are cross-sectional views, showing an insert 3 that has been placed into the socket 2 of the body 1, with the optional secondary shim 71 provided in the gap between the insert 3 and the socket 2. A primary shim 61 has been pushed partly in the gap between the insert 3 and the socket 2.

The primary shim 61 is inserted in the gap with its tapered thickness side first. Hence, once the primary shim 61 has been pushed partly in the gap, the tapered side is arranged towards the floor of the socket 2 and the side having the greater thickness protrudes out of the socket 2 beyond the wear surface 11.

If one or more secondary shims 71 are used, the primary shim 61 may be positioned diametrically opposite the secondary shims 71 relative to the diameter of the insert 3 and socket 2 (FIG. 3(c)), or at the same position along the circumference of the insert 3 and/or along the inner surface of the socket 2 as the secondary shim 71 (FIG. 3(d)).

One or more further primary shims 61 can be added (FIG. 3(e) and 3(f)) so as to form a stack with the initial primary shim 61. This may be particularly desirable if the gap between the insert 3 and the socket 2 is relatively large. The number of primary shims 61 is chosen depending on the size of the gap between the insert 3 and socket 2. For example, as schematically illustrated in FIG. 3(f), three primary shims 61 are placed in a stack insert on top of the insert 2 (as seen when the wear part, e.g., the mantle, is in an upright position). The number of primary shims 61 should be such that the shims can be hammered down for a good mechanical grip.

A plurality of primary shims 61 do not necessarily form a stack, but may be distributed within the gap along the circumference of the insert 3 and/or along the inner surface of the socket 2. For example, shims 61 may be placed at diametrically opposite positions (e.g., above and below the insert, if the wear part (e.g., the mantle) is placed upright) to prevent excessive tilting of the insert 3 within the socket 2. Single shims 61 and/or individual stacks of shims 61 may be distributed within the gap along the circumference of the insert 3 and/or along the inner surface of the socket 2, e.g., placed at diametrically opposite positions. In this way, the insert 3 can be securely retained, even if the size of the insert 3 is substantially smaller than the socket 2.

Around ⅓ of the length of the primary shims 61 should protrude from the socket 2 in this state, to make sure there is tight contact between insert and cavity.

By means of a hammer, the primary shims 61 are then forced in between the insert 3 and the socket 2 (depicted by the arrow in throughout FIG. 3(c) to (e)) until they are substantially flush with the wear surface of the mantle. All of the primary shims 61 in a stack should be hammered into the gap simultaneously, rather than one after the other, in order to achieve a tight fit. Any remaining protruding parts of the primary shims 61 may be cut or ground away.

Once the primary shims 61 have been hammered down and any protruding parts have been removed, a coating or paint layer may be applied. Any remaining gaps between the insert and the socket do not need to be filled with glue.

### Third Embodiment

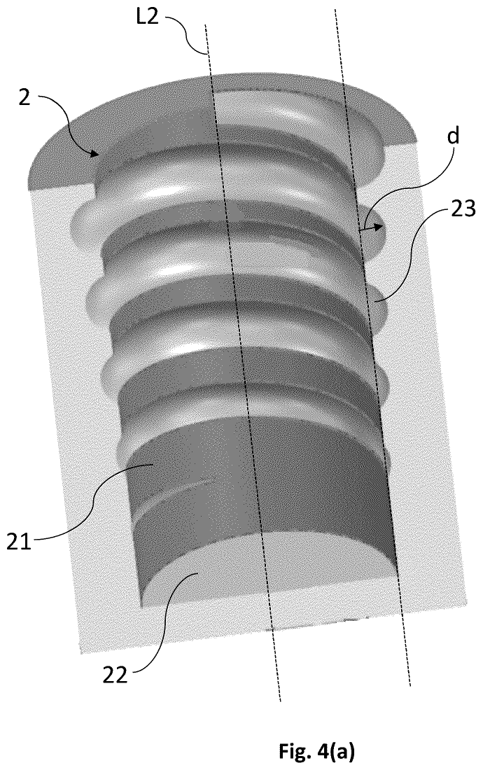

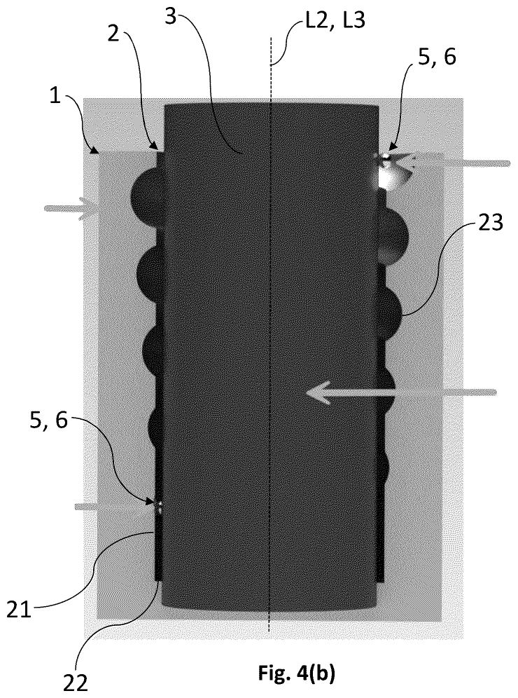

With reference to FIG. 4(a) and 4(b), a third embodiment for fastening inserts 3 to a body or casting 1 will be described.

This embodiment relies, broadly speaking, on a tapered recess formed in the peripheral side wall 21 of the socket 2 in the base casting 1, with spherical members (e.g., balls) being received in the tapered recess. Rotating or pressing the insert 3 into place jams the metal balls between the insert 3 and the side wall 21 of the socket 2, locking the insert 3 in place as an interference fit between the casting 1 and the insert 3 is created.

The material of the balls is softer than the material of the base casting 1 and the insert 3, so that the balls are capable of being deformed when being placed in the recess between the insert 3 and the base casting 1, although the balls do not necessarily deform. The balls may be formed of a metal material, such as steel, copper, or aluminium, a metal alloy material, such as brass, or a polymer material, such as plastic.

FIG. 4(a) is a cross-sectional view of a socket 2 formed in a body 1. In this embodiment, the tapered recess has the form of a spiral groove 23.

The tapered recess is not necessarily spirally formed, but may have any other shape that results in the balls being jammed between the insert 3 and the sidewall 21 of the socket 2 when rotating or pressing the insert 3 into place. For example, the tapered recess may extend relatively straight from the opening towards the floor 22 of the socket 2, with an angled portion at the end of the recess towards the floor 22 of the socket 2. The recess may also not necessarily be tapered along its entire extension, but, e.g., only at its end toward the floor 22 of the socket 2.

FIG. 4(b) illustrates a working principle of retaining a wear resistant insert in the socket of FIG. 4(a) by means of a retainer comprising one or more spherical members according to the third embodiment of the present invention.

As is apparent from the Figures, the spiral groove 23 is wider at the open end of the socket 2 and becomes shallower towards the floor 22 of the socket 2. Thus, when a ball is placed in the spiral groove between the insert 3 and the inner wall 21 and made to move along the spiral groove towards the floor 22 of the socket 2, the ball is continuously further pressed in accordance with the reduction in width of the spiral groove 23 until a tight fit has been achieved. The ball may deform under the compressive load between the insert 3 and the sidewall 21 of the socket 2.

In case more than one ball is inserted in the groove, balls may come into contact with each other, and may even stack up and lie against each other to bridge the gap between the insert 3 and the groove 23. Hence, once the balls are made to move along the groove 23, they may not only be jammed between the insert 3 and the sidewall 21 of the socket 2, but several balls may also be pressed against each other. In this way, a tight fit can be achieved along the entire groove, even in portions of the groove where a diameter of an individual ball is less than the depth of the groove.

Accordingly, this embodiment provides a friction fit along the spiral groove. This solution comes at low cost, is quickly applicable allows for a wide tolerance range in the base casting.

Each of the various embodiments described above entails, in a broad sense, the placement of deformable retainers inside the sockets alongside with the inserts. By means of the retainers, the wear resistant inserts are mechanically retained in the sockets of the base casting, ideally without any adhesive or similar bonding material. Depending on the circumstances, a certain amount of adhesive or other suitable bonding material (e.g., an epoxy) may be used to complement the mechanical retention, however.

### LIST OF REFERENCE SIGNS

1 body, crushing body
2 socket
21 sidewall
22 floor
23 groove
d depth of groove
L2 longitudinal axis of the socket
3 wear resistant insert
31 first end
32 second end
33 flattened portion
5 retainer
51 shaft part
52 expandable part
53 expandable section
531 first leg
532 second leg
54 expandable section
55a juncture
55b juncture
6 anchor pin
61 primary shim
7 second retaining component
71 secondary shim
L3 longitudinal axis of the wear resistant insert
10 wear part, crusher component
11 surface, crushing surface, wear surface

What is claimed is:

1. A method of manufacturing a wear part, said method comprising the following steps:
providing a body comprising at least one socket formed in or on the body,
providing at least one insert of a wear resistant material configured to be received by the socket, and
retaining the wear resistant insert in the socket by means of a retainer,
wherein with the wear resistant insert at least partially received by the socket, a first retaining component of the retainer is at least partially inserted into a gap between the wear resistant insert and the body, and
a force (F) is applied onto the first retaining component and/or onto the wear resistant insert, to thereby create a retaining force to retain the wear resistant insert within the socket.

2. The method according to claim 1, wherein the retaining force provided by the retainer restricts relative translatory movement between the wear resistant insert and the body, to retain the wear resistant insert within the socket.

3. The method according to claim 1, wherein the retainer mechanically joins the wear resistant insert and the body to each other upon application of the force (F) on the first retaining component and/or on the wear resistant insert, the mechanical joint being a friction fit, a form fit, an interference fit, a press-fit, or combinations thereof.

4. The method according to claim 1, wherein applying the force (F) on the first retaining component and/or on the wear resistant insert causes a further insertion movement of the first retaining component into the gap between the wear resistant insert and the body.

5. The method according to claim 1,
wherein the socket receives the wear resistant insert by inserting the wear resistant insert into the socket along an insertion direction, and
wherein the force (F) applied on the first retaining component of the retainer is applied along the insertion direction or a direction parallel thereto.

6. The method according to claim 1, wherein the force (F) applied on the wear resistant insert is a torque causing rotation of the wear resistant insert around its longitudinal axis.

7. The method according to claim 1, wherein the retainer deforms upon application of the force on the first retaining component and/or on the wear resistant insert to provide the retaining force to thereby retain the wear resistant insert in the socket, wherein the retainer deforms by being compressed between the wear resistant insert and the body.

8. The method according to claim 1, wherein the first retaining component is made to expand upon application of the force thereon, to thereby provide the retaining force for retaining the wear resistant insert in the socket.

9. The method according to claim 1, the method further comprising the step of:
providing a second retaining component of the retainer in the gap between the wear resistant insert and the body,
wherein the first retaining component comprises one or more shims of a first material, and the second retaining component comprises one or more shims of a second material,
wherein the hardness of the first material is greater than or equal to the hardness of the second material, and
wherein the second retaining component deforms upon application of the force on the first retaining component.

10. The method according to claim 1,
wherein the socket comprises at least one sidewall and a floor,
the socket being provided with a groove recessed from a surface of the sidewall,
wherein, when the insert is received by the socket, a maximum distance along a direction perpendicular to the longitudinal axes (L2, L3) of the insert and the socket between the groove and a peripheral surface of the wear resistant insert decreases towards the floor of the socket,
wherein the first retaining component comprises one or more substantially spherical members.

11. A wear part, comprising:
a body comprising at least one socket formed in or on the body;
at least one insert of a wear resistant material configured to be received by the socket; and
a retainer configured to retain the wear resistant insert within the socket, wherein
the retainer comprises a first retaining component configured to be at least partially inserted within a gap between the wear resistant insert and the body while the wear resistant insert is at least partially received by the socket,
wherein the retainer is configured to provide, upon application of a force on the first retaining component and/or on the wear resistant insert, a retaining force to retain the wear resistant insert in the socket.

12. The wear part according to claim 11, wherein the retainer is configured to provide the retaining force to restrict relative translatory movement between the wear resistant insert and the body, to retain the wear resistant insert in the socket.

13. The wear part according to claim 11, wherein the retainer is configured to mechanically join the wear resistant insert and the body to each other upon application of the force on the first retaining component and/or on the wear resistant insert, the mechanical joint being a friction fit, a form fit, an interference fit, a press-fit, or combinations thereof.

14. The wear part according to claim 11, wherein the first retaining component is configured to be further inserted into the gap between the wear resistant insert and the body by applying the force on the first retaining component and/or on the wear resistant insert.

15. The wear part according to claim 11, wherein the socket is configured to receive the wear resistant insert by inserting the wear resistant insert along an insertion direction into the socket, and wherein the retainer is configured to provide the retaining force upon application of the force on the first retaining component of the retainer along the insertion direction or a direction parallel thereto.

16. The wear part according to claim 11, wherein the wear resistant insert is configured to receive a torque causing rotation of the wear resistant insert around its longitudinal axis.

17. The wear part according to claim 11, wherein the retainer is configured to deform upon application of the force on the first retaining component and/or on the wear resistant insert to provide the retaining force to thereby retain the wear resistant insert in the socket, wherein the retainer is configured to deform by being compressed between the wear resistant insert and the body.

18. The wear part according to claim 11, wherein the first retaining component is configured to expand upon application of the force thereon, to provide the retaining force to thereby retain the wear resistant insert in the socket.

19. The wear part according to claim 11, wherein the retainer further comprises a second retaining component, the second retaining component being configured to be provided in the gap between the wear resistant insert and the body,
wherein the first retaining component (6) comprises one or more shims of a first material, and the second retaining component comprises one or more shims of a second material,
wherein the hardness of the first material is greater than or equal to the hardness of the second material, and
wherein the second retaining component is configured to deform upon application of the force on the first retaining component.

20. The wear part according to claim 11, wherein the socket comprises at least one sidewall and a floor, the socket being provided with a groove recessed from a surface of the sidewall,
wherein, when the insert is received by the socket, a maximum distance along a direction perpendicular to the longitudinal axes of the insert and the socket between the groove and a peripheral surface of the wear resistant insert decreases towards the floor of the socket,
wherein the first retaining component comprises one or more substantially spherical members.
